(19) United States
(12) Patent Application Publication
(10) Pub. No.: US 2015/0181041 A1
(43) Pub. Date: Jun. 25, 2015

(54) Intelligently Routing Inbound Communication

(71) Applicant: InsideSales.com, Inc., Provo, UT (US)

(72) Inventors: David Randal Elkington, Mapleton, UT (US); Xinchuan Zeng, Orem, UT (US)

(21) Appl. No.: 14/140,439

(22) Filed: Dec. 24, 2013

(51) Int. Cl. H04M 3/523

(52) U.S. Cl. CPC H04M 3/5235

(57) ABSTRACT

Intelligently routing inbound communication. In one example embodiment, a method for routing an inbound communication includes several steps. First, a notification of the inbound communication is received that includes intrinsic information about the initiator of the communication. Next, the intrinsic information about an initiator of the communication is used to retrieve non-intrinsic information about the initiator of the communication from a data store. Finally, the non-intrinsic information is used to determine a probable destination of the communication by inputting at least some non-intrinsic information into a machine learning model to rank the available destinations.

### FIELD

The embodiments discussed herein are related to techniques for routing inbound telecommunication to the most appropriate destination.

### BACKGROUND

Telecommunication within an organization is generally handled by automated or semi-automated tools for routing the communication to the most appropriate destination. Fully automated tools, such as an Automatic Call Distributor (“ACD”), are used when the most appropriate destination is a group of people. Semi-automated tools, such as an Interactive Voice Response (“IVR”) system, rely on some user input to determine the appropriate destination. This user input may include a description of the issue to which the communication relates, or an indication of the group or individual to which the user wants to be routed. Each of these types of systems relies on rules which may not be optimized to the needs of the specific user attempting communication.

One main difficulty in routing communication lies in inefficiencies regarding which person or group in an organization is the most appropriate one with which to communicate. These difficulties can manifest as discontinuity in strings of communication events. More particularly, when contacting an organization it can be difficult to reach the most appropriate person or group, such as the person or group associated with a specific set of issues or involved in previous communicative events.

Organizations may provide potential callers with many different numbers which are all owned by the same organization, so the number dialed may not provide enough information to allow for the call to be efficiently routed. This problem is particularly acute if an agent uses a dynamic caller ID number when making contact with a caller.

More specifically, there exists the capability for agents to use a pool of unassigned numbers and select from those numbers the one that is most local to the call recipient. In order for multiple agents to utilize the same pool of numbers, the numbers cannot be assigned to a specific agent. Therefore, if a caller uses one of the pool of numbers to contact an organization, there may be no way to route the call based only on what number was dialed.

In many situations, there may be more than one agent who has attempted to contact a caller. For example, multiple agents may have attempted a call using the same number on a caller ID, or agents could have used that number across multiple communication channels, such as the number identified with a phone call or text message, a voicemail which invites the recipient to call that number, and an email which invites the recipient to call the same number. In these situations it may be difficult to determine which event actually initiated the call, and therefore which agent the caller is attempting to reach.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

The accompanying drawings illustrate several example embodiments of the invention. Together with the description, they serve to explain the principles of the invention according to the embodiments. One skilled in the art will recognize that the particular embodiments illustrated in the drawings are merely exemplary, and are not intended to limit the scope of the present invention.

FIG. 1 is a block diagram depicting an example of hardware and software architecture for routing inbound communication.

FIG. 2 is a block diagram depicting an example of hardware and software architecture for a communication routing application.

FIG. 3 is a flowchart depicting a method of receiving a communication and determining the optimal destination according to one example embodiment.

FIG. 4 is a flowchart depicting a method of receiving a communication and determining a set of most optimal destinations and applying a set of routing rules according to one example embodiment.

### DESCRIPTION OF EMBODIMENTS

Various embodiments are described more fully below with reference to the accompanying drawings, which form a part hereof, and which show specific exemplary implementations for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation, or an implementation combining software and hardware aspects. The following detailed description is, therefore, not to be taken in a limiting sense.

The logical operations of the invention may be performed in various embodiments. For example, embodiments of the invention could be practiced as a sequence of computer implemented steps running on a computing system and/or as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

These embodiments discuss the routing of a phone call, but those skilled in the art will understand the invention could be deployed to route messages through other communication channels, such as email, SMS, fax, and social media messaging.

When an organization receives a communication there is usually a question regarding where the communication should be routed. Organizations handle this in different ways which vary from having a person route the communication manually to having the initiator of the communication give input to assist in routing to the initiator's intended recipient. The latter approach is more common and in the case of a phone call typically involves the use of Interactive Voice Response (“IVR”) systems which allow a caller to select options from a menu to assist in routing the call.

One example embodiment of the invention routes an incoming communication from an individual based on the previous activity related to that individual such as, for example, the agent who last communicated with the individual. A learning machine model is employed to evaluate all of the individual's contact history to make call routing decisions, such as whether to route the inbound call to an Automated Call Distributor (“ACD”) or to a specific team or agent. This embodiment of the invention also utilizes a learning algorithm to route incoming calls. Routing decisions may be based on data about the caller and data relating to previous interaction with the caller including, but not limited to, the last agent to contact or attempt to contact the caller, or the length of time since the last contact with the caller.

In one example embodiment, a system includes an application server configured to receive inbound communication, a communication processor configured to manage the incoming and outgoing communication, a routing application to tell the communication processor where to route the communication and a data store configured to store information which may be used to determine the optimal destination.

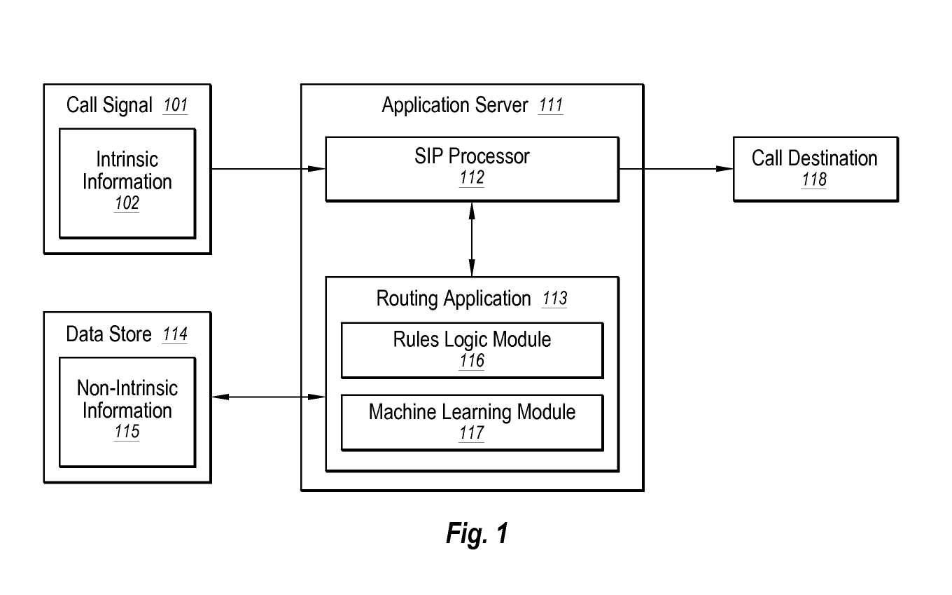

Referring now to FIG. 1, there is shown a block diagram depicting a hardware and software architecture for routing communication. Call Signal 101 is initiated by a caller. Call Signal 101 includes Intrinsic Information 102, such as the number the call was initiated from and the time of the call. Application Server 111 runs a Session Initiation Protocol (“SIP”) Processor 112 to receive incoming call signals 101 from the Public Switched Telephone Network (“PSTN”) and collect Intrinsic Information 102. The embodiment further comprises a Routing Application 113 configured to query Data Store 114 to retrieve Non-intrinsic Information 115, which may include data about previous interactions with the caller such as the identity of the agents with whom the caller has previously spoken.

In an example embodiment, Data Store 114 may be a Customer Relationship Management (“CRM”) database. CRM databases and similar systems allow organizations to gather and store non-intrinsic data about communication events. Non-intrinsic Information 115 can include who was being communicated with, which agent attempted to communicate, whether the agent successfully made contact, and notes regarding what, if anything, was discussed or otherwise communicated. Non-intrinsic Information 115 could further include other information about the agent or the customer, such as personality information, social preference, political affiliations, organizational membership, a profile of a social network, or any other data which could impact the communicative interaction.

Routing Application 113 then feeds the Intrinsic Information 102 and Non-intrinsic Information 115 into Rules Logic Module 116 and Machine Learning Module 117 to make call routing decisions which are sent back to SIP Processor 112. SIP Processor 112 then routes the call to the appropriate destination or presents the user with options for routing the call that are tailored to the Intrinsic Information 102 and Non-intrinsic Information 115.

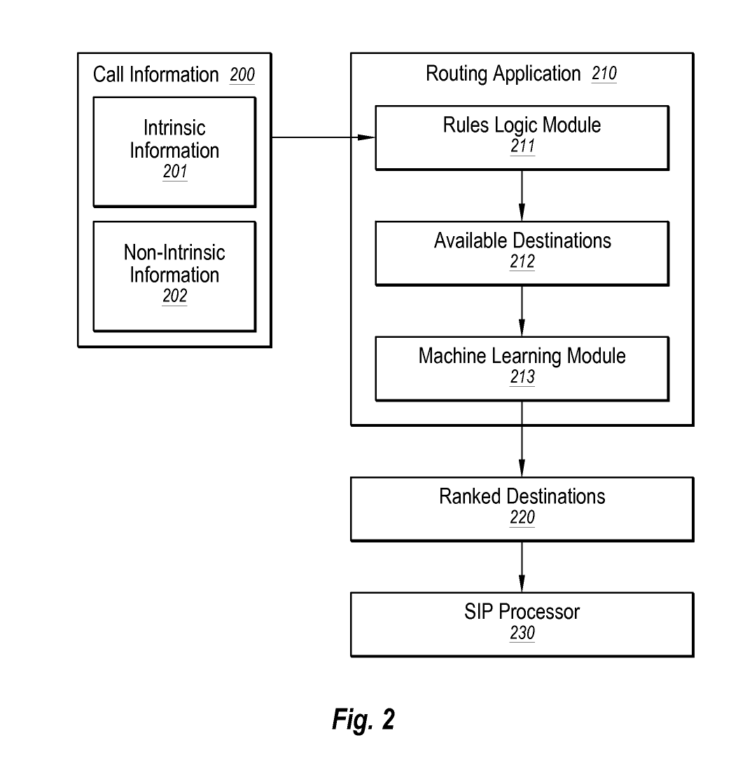

Referring now to FIG. 2, there is shown a block diagram depicting hardware and software architecture for practicing an example embodiment. Upon receiving Caller Information 200, which includes Intrinsic Information 201 and Non-intrinsic Information 202, Routing Application 210 uses Rules Logic Module 211 to generate a list of Available Destinations 212. If the number of available destinations is above a predetermined threshold, the list of Available Destinations 212 is passed to Machine Learning Module 213. Machine Learning Module 213 then ranks the list of Available Destinations 212 and outputs a list of Ranked Destinations 220 to SIP processor 230.

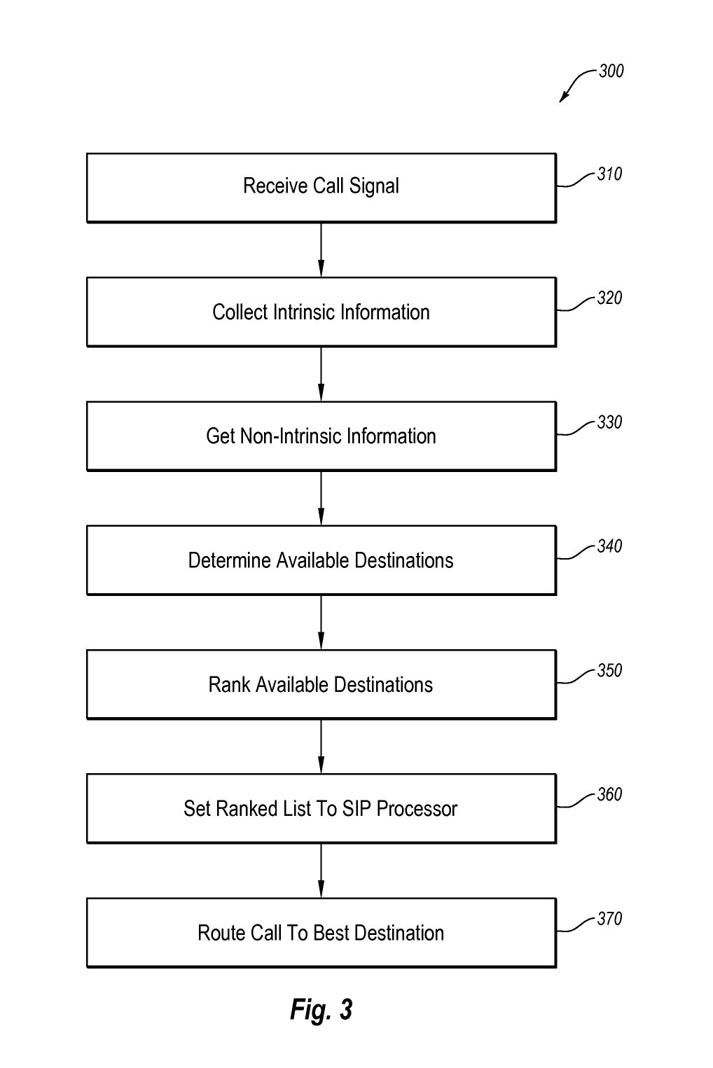

Referring now to FIG. 3, there is shown a flow chart for routing an incoming call. In at least one embodiment, the steps of FIG. 3 are performed by a processor at Application Server 111 of FIG. 1, although one skilled in the art will recognize that the steps can be performed by any suitable component.

Method 300 may begin at block 310 wherein a call signal is received, with the call signal containing intrinsic information.

At block 320, this intrinsic information is collected by an application such as, for example, Routing Application 113 of FIG. 1.

At block 330, non-intrinsic information is collected by the application.

At block 340, available destinations are determined. For example, Routing Application 210 can send Caller Information 200 to Rules Logic Module 211 of FIG. 2 to determine which destinations are available for this call and output those available destinations to Machine Learning Module 213 of FIG. 2.

At block 350, the available destinations are ranked. For example, Machine Learning Module 213 can use Caller Information 200 of FIG. 2 to rank the list of Available Destinations 212. One example embodiment uses a learning machine model to evaluate data from past communication related to an incoming caller and determine which agent the caller is trying to reach or which agent was the most likely catalyst for the inbound call. The machine learning model also analyzes non-intrinsic information about the caller. Non-intrinsic information may be information associated with the past communication and could include, for example, which number(s) the caller dialed, when the caller has called, which agent(s) the caller previously spoke to, and what data the agent(s) logged about the call. In the case of multiple agents using different contact media, the machine learning model could evaluate past interactions with the caller to see to which agent or communication channel the caller is most likely attempting to respond.

In general, the task performed by the system and method of this example embodiment can be formulated as follows.

L is a set of possible destinations for the incoming communication. If the communication is a phone call, L could be an individual agent, an ACD, or a department represented as:
Destinationₛ={destinationₛ_{ᵢ}, destinationₛ_{₂}, . . . , destinationₛ_{_{L}}}

The destinations for Destinationsₛ are selected from an equal or larger set Destinations.Each Destination in Destinationsₛ will have an associated score:
Scoresₛ={scoresₛ₁, scoresₛ₂, . . . , scores_{sL}}

M is a set of agents who have previously interacted with the caller. An agent, Agentₚ_{_{[recent]}}, is the agent who had the most recent interaction with the caller, with the set of agents composed as follows:
Agentₚ={Agentₚ_{₁}, Agentₚ_{₂}, . . . , Agentₚ_{_{M}}}

There is a probability that a caller will call about the same topic of the most recent interaction, which is represented as:
P(same topic)

This probability can be predicted based on previous interactions and results. If P(same topic) is high, the destination Agentₚ_{_{[recent]}} should have a high probability of being the most appropriate destination. This does not preclude other destinations from receiving high scores. If P(same topic) is low, then the default destination for the topic may be chosen for the caller.

In one example embodiment, the probability can be predicted using a two-level prediction model. This embodiment uses a multi-layer perceptron (“MLP”) neural network trained with backpropogation, hereinafter MLP₁. However, those skilled in the art will recognize that many other machine learning models could be employed in place of the MLP neural network.

The first level prediction model MLP₁ will predict the probability P(same topic), as well as predict the scores Scoresₛ. For example, if a record of a recent interaction with the caller indicates a status of “unresolved,” then there is a higher likelihood that subsequent calls will be about the same topic. If an agent A leaves a message or sends an email to ask a lead to call about topic T, then the next inbound call from that caller is likely about T and should be forwarded to A. MLP₁ will output a ranked list of Destinationₛ and Scoresₛ. If P(same topic) is above some threshold (such as 0.8), then an example embodiment may output the original ranked list as the final suggested list.

For ease of implementation, values such as L and M could be set to a fixed, relatively small value, to facilitate consideration of a relatively small subset of possible destinations. The inputs and outputs for destinations in MLP₁ could be arranged in a fixed order based on recency of interactions. Neural networks are composed of processing elements commonly referred to as neurons or nodes. The arrangement of the nodes can be based on the expected inputs and outputs. It is possible to consider fewer destinations than input nodes, in which case the extra output nodes could be ignored.

A second level prediction model, MLP₂, may be used if the first level prediction model, MLP₁, does not predict P(same topic) above a predetermined threshold. The second level prediction model may predict what the most likely topic is among a set of N topics. Such a set may include a predefined list of most common topics. MLP₂ could be trained using historical data. For example, if the phone number for the caller has no records of previous interaction, some topics may be more likely than others (e.g. “requesting demo” would be more likely than “support”). MLP₂ may then output a ranked list of destinations, Destinationsₜ with scores, Scoresₜ.

At block 350, one example embodiment could generate a combined score using P(same topic) as the weighting. Scores for Destinationₛ and Destinationsₜ could be weighted by P(same topic) and (1-P(same topic)), respectively. The two lists could then be combined and sorted by the weighted scores.

At block 360, the ranked list is sent to SIP Processor 230 of FIG. 2. For example, Routing Application 210 of FIG. 2 may select the top L from the combined list and send it SIP Processor 230. When P(same topic) is in a middle range (such as 0.4-0.6), members from the two lists may compete with each other, and the final list may be a composite list from the two output lists for MLP₁ and MLP₂. If P(same topic) is high, or low, the final output list may include only the elements of one or the other list.

At block 370, the call is routed to the most appropriate destination. For example, based on the direction received from Routing Application 210, SIP Processor 220 routes the call signal to the most appropriate destination.

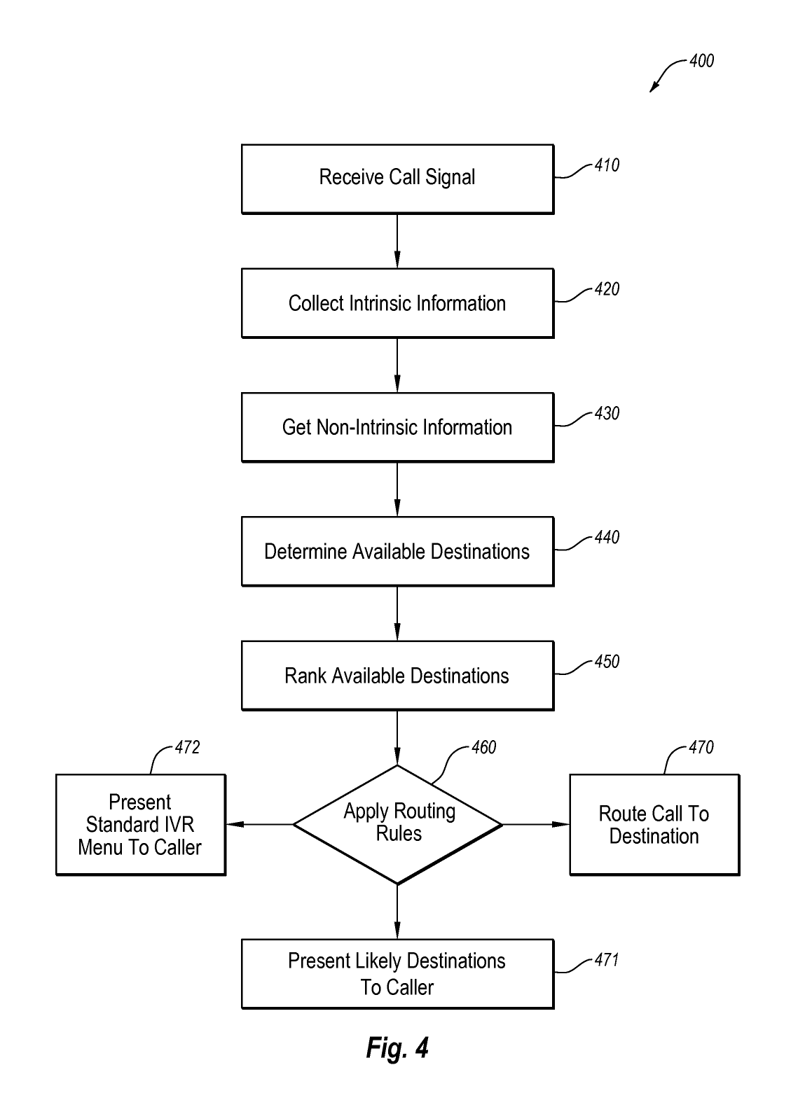

Referring now to FIG. 4, there is shown a flow chart for routing an incoming call. In at least one embodiment, the steps of FIG. 4 are performed by a processor at Application Server 111 of FIG. 1, although one skilled in the art will recognize that the steps can be performed by any suitable component.

Method 400 may begin at block 410 wherein a call signal is received, with the call signal containing intrinsic information.

At block 420, this intrinsic information is collected by an application such as, for example, Routing Application 113 of FIG. 1.

At block 430, non-intrinsic information is collected by the application.

At block 440, available destinations are determined. For example, Routing Application 210 can send Caller Information 200 to Rules Logic Module 211 of FIG. 2 to determine which destinations are available for this call and output those available destinations to Machine Learning Module 213 of FIG. 2.

At block 450, the available destinations are ranked. For example, Machine Learning Module 213 can use Caller Information 200 of FIG. 2 to rank the list of Available Destinations 212.

At block 460, if the top destination has a high confidence, then SIP Processor 230 of FIG. 2 can move to block 470 to route the call to that destination with no input from the user. One example of high confidence is when the destination score is above a predetermined threshold. Another example is when a destination score is distinctly higher than other destination scores. If the top destination does not have a high confidence, then the Routing Application 210 of FIG. 2 can provide a list of the top destinations for the caller to select manually, which could include an option to go to a traditional IVR. If there are multiple destinations with a high confidence, then the system could move to block 471 and present all the likely destinations to the caller. If there are no likely destinations, then the system can move to block 472 and provide a conventional IVR menu to the caller.

FIG. 4 depicts one example embodiment of how one example method may process some available call routing options, although one skilled in the art will recognize that there are other routing options are available and any available options may be processed differently in alternative embodiments.

Any of these embodiments could interface with the caller in various ways. For example, the caller could simply be routed to the most likely destination without any option. Alternatively or additionally, the caller could be presented with the top options from the ranked list and be allowed to choose one of those options or to utilize a traditional IVR system.

Some potential advantages of the embodiments disclosed herein may include, without limitation, the ability to determine the best destination for a call and to more efficiently route inbound calls made to dynamic or unassigned phone numbers, which may create a better experience for a potential client and may be more likely to lead to a positive interaction including, but not limited to, a sale.

While the foregoing written description of example embodiments of the invention enables one of ordinary skill to make and use what is considered presently to be the best mode thereof, those of ordinary skill will understand and appreciate the existence of variations, combinations, and equivalents of the specific embodiments, methods, and examples herein. The invention should therefore not be limited by the above described embodiments, methods, and examples, but by all embodiments and methods within the scope of the invention as claimed.

What is claimed is:

1. A method for intelligently routing an inbound communication, comprising:
receiving a notification of the inbound communication, wherein the notification includes intrinsic information about the initiator of the communication;
using the intrinsic information about an initiator of the communication to retrieve non-intrinsic information about the initiator of the communication from a data store; and
using the non-intrinsic information to determine a probable destination of the communication by inputting at least some non-intrinsic information into a machine learning model to rank available destinations.

2. The method of claim 1, wherein the communication is one of:
a phone call,
an email,
an SMS message,
a fax, or
a social media message.

3. The method of claim 1, wherein the data store is a database.

4. The method of claim 3, wherein the database is a Customer Relationship Management (“CRM”) database.

5. The method of claim 1, wherein the machine learning model is a neural network.

6. The method of claim 5, wherein the machine learning model is a multi-layer perceptron neural network.

7. The method of claim 1, further comprising routing the communication to the highest ranked available destination.

8. The method of claim 1, further comprising presenting the initiator of the communication with a selection of likely destinations and allowing the initiator of the communication to select at least one of the selection of likely destinations.

9. The method of claim 8, wherein the selection of likely destinations includes either:
a predetermined number of destinations; or
all destinations which were above a predetermined threshold of probability.

10. The method of claim 1, wherein the machine learning model is a neural network.

11. The method of claim 1, wherein the non-intrinsic information stored about the initiator includes at least a personality profile.

12. At least one computer-readable medium comprising an article of manufacture that is encoded with computer-executable instructions that, when executed by a computing device, cause the computing device to perform a method for intelligently routing an inbound communication, the method comprising:
receiving a notification of the inbound communication, wherein the notification includes information about the initiator of the communication;
using the information to retrieve additional information about the initiator of the communication from a data store; and
using the additional information to determine a probable destination of the communication by inputting the information and the additional information into a machine learning model to rank available destinations.

13. The at least one computer-readable medium of claim 12, wherein the communication is one of:
a phone call,
an email,
an SMS message,
a fax, or
a social media message.

14. A system for intelligently routing an inbound communication, comprising:
a communication server configured to receive the inbound communication and identify information about the initiator of the communication;
a data store which contains additional information about the initiator of the communication and about other potential initiators of inbound communications; and
an IVR server configured to use a machine learning model to score potential destinations for the communication based on the information and the additional information about the initiator of the communication.

15. The system of claim 14, wherein the communication server is an SIP server.

16. The system of claim 14, wherein the data store is a CRM database.

17. The system of claim 14, wherein the machine learning model is a neural network.

18. The system of claim 17, wherein the neural network is a multi-layer perceptron neural network.

19. The system of claim 14, further comprising an additional data store which contains information about potential recipients of the communication.

20. The system of claim 19, wherein the additional data store includes at least personality profiles about potential recipients.

21. The system of claim 14, wherein the communication is one of:
a phone call,
an email,
an SMS message,
a fax, or
a social media message.
